(19) United States
(12) Patent Application Publication
(10) Pub. No.: US 2018/0183146 A1
(43) Pub. Date: Jun. 28, 2018

(54) CIRCUITS AND TECHNIQUES FOR A VIA-LESS BEAMFORMER

(71) Applicant: Raytheon Company, Waltham, MA (US)

(72) Inventors: Thomas V. Sikina, Acton, MA (US); John P. Haven, Lowell, MA (US); Philip M. Henault, Medway, MA (US); Alkim Akyurtlu, Arlington, MA (US)

(73) Assignee: Raytheon Company, Waltham, MA (US)

(21) Appl. No.: 15/390,764

(22) Filed: Dec. 27, 2016

(51) Int. Cl. H01Q 3/34; G01S 13/02

(52) U.S. Cl. CPC H01Q 3/34; H01P 5/16; G01S 13/02

(57) ABSTRACT

A via-less beamformer provided from a plurality of circuits elements having circuit layouts selected to mitigate unwanted reactive coupling there between. At least one of the plurality of circuit elements is provided having a circuit layout selected based upon reactive field theory. In one embodiment, a circuit layout may be selected by: determining which circuit features of the circuit elements produce reactive fields in response to a signal provided thereto, separating the total field into a modal set and determining the modal weighting coefficients based on geometrical and/or design features of the of the circuit elements. In one embodiment the via-less beamformer comprises one or more via-less combiner/divider circuits. In one embodiment the via-less beamformer comprises one or more branch hybrid coupler circuits. In one embodiment the via-less beamformer comprises one or more via-less combiner/divider circuits and one or more branch hybrid coupler circuits.

### BACKGROUND

As is known in the art, phased array systems may include a beamformer for directional signal transmission and reception. Existing beamformers are provided as high density printed wiring board (PWB) circuits. The proximity of circuits on the PWB can give rise to unwanted coupling effects. For example, the electric field modes found in a typical stripline circuit include the intended, often dominant transverse electromagnetic (TEM) mode, along with both evanescent and propagating transverse magnetic (TM) and transverse electric (TE) modes. These non-TEM modes are considered as a reactive set, in that they form an unintended coupling path between circuit elements.

In some existing phased array systems, coupling effects between PWB circuit elements may be reduced using additional structural components to prevent undesirable coupling between circuit components. For example, conventional phased arrays systems may include a series (or “fence”) of conductive vias to suppress propagation of higher-order (i.e., unwanted) modes between PWB circuit elements.

### SUMMARY

It is appreciated herein that the use of conductive vias add several steps to the printed wiring board (PWB) manufacturing process and are a significant cost driver. In addition, conductive vias add complexity to the design, since often these vias interfere with routing desired signal paths on various layers in a multi-layer PWB. Moreover, conductive vias typically require using a subtractive manufacturing technique.

Described herein are circuits for via-less beamformers (i.e., beamformers that do not rely on conductive vias for mode suppression). Embodiments of a via-less beamformer may include high electrical performance relative to existing beamformer circuits, may facilitate low-cost additive manufacturing (AM) of phased arrays, and may have broad applicability to a wide variety of phased array applications. Also described herein are circuit design techniques based on reactive field theory and modal expansion that can be used to select acceptable beamformer circuit layouts in the absence of conductive vias.

In one aspect, a via-less beamformer is provided from a plurality of circuits elements having circuit layouts selected to mitigate unwanted reactive coupling there between. At least one of the plurality of circuit elements is provided having a circuit layout selected based upon reactive field theory. In one embodiment, a circuit layout may be selected by: determining which circuit features of the circuit elements produce reactive fields in response to a signal provided thereto, separating the total field into a modal set and determining the modal weighting coefficients based on geometrical and/or design features of the of the circuit elements.

In one embodiment the via-less beamformer comprises one or more via-less combiner/divider circuits. In one embodiment the via-less beamformer comprises one or more branch hybrid coupler circuits. In one embodiment the via-less beamformer comprises one or more via-less combiner/divider circuits and one or more branch hybrid coupler circuits.

By providing circuits which do not require vias for suppression of undesirable signals (e.g. mode suppression), it is possible to combine such via-less circuits to provide via-less beamformer circuits as well as other circuits suitable for use in a phased array radar, for example. Thus, coupling effects between PWB circuit elements may be reduced without using additional structural components to prevent undesirable coupling between circuit components. For example, it is not necessary to include a series (or “fence”) of conductive vias to suppress propagation of higher-order (i.e., unwanted) modes between PWB circuit elements in a beamformer circuit. Hence a via-less beamformer circuit may be provided. Since conductive vias are not needed to suppress propagation of RF signals, such via-less beamformer circuits are less expensive to manufacture than conventional beamformer circuits which utilize conductive vias for suppression of undesirable RF signals.

### BRIEF DESCRIPTION OF THE DRAWINGS

The foregoing features may be more fully understood from the following description of the drawings in which:

FIG. 1 is a block diagram of an illustrative phased array radar system that may include a via-less beamformer, in accordance with embodiments of the disclosure;

FIG. 2 is an isometric view of a 2:1 divider/combiner circuit that may form a part of a via-less beamformer, in accordance with embodiments of the disclosure;

FIG. 3 is a top-view of a 4:1 divider/combiner circuit that may form a part of a via-less beamformer, in accordance with embodiments of the disclosure; and

FIG. 4 is an isometric view of a branch hybrid coupler circuit that may form a part of a via-less beamformer, in accordance with embodiments of the disclosure.

The drawings are not necessarily to scale, or inclusive of all elements of a system, emphasis instead generally being placed upon illustrating the concepts, structures, and techniques sought to be protected herein.

### DETAILED DESCRIPTION

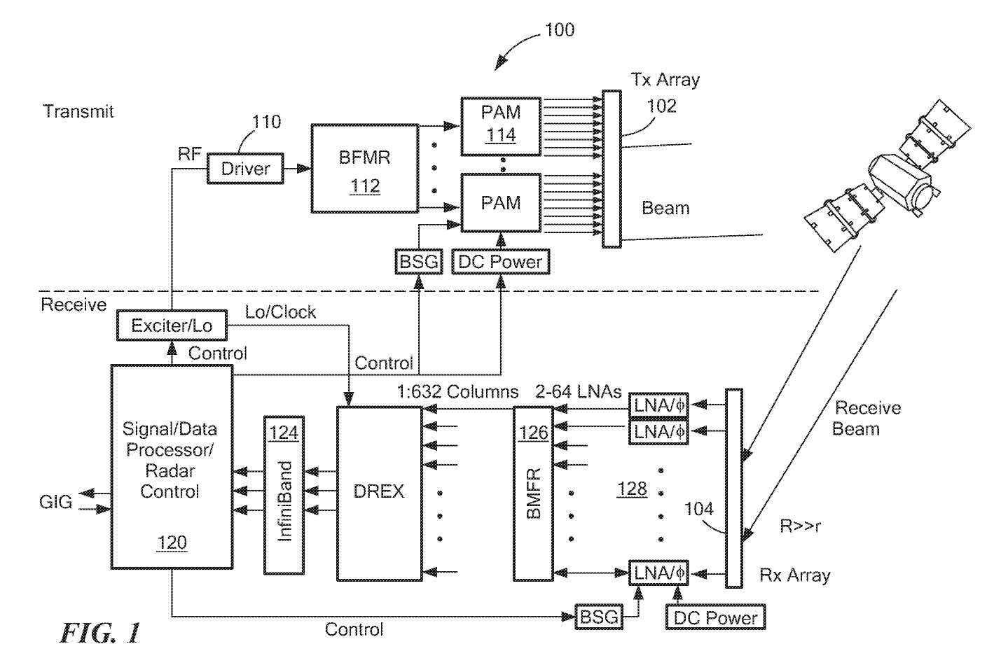

FIG. 1 shows an illustrative phased array radar system 100, according to embodiments of the disclosure. The illustrative system 100 includes separate transmit and receive arrays 102, 104 with a remote target shown as a satellite. In other embodiments, the same antenna may be used for transmit and receive functions as is generally known. On the transmit side, the system 100 includes a driver 110 coupled to a transmit beamformer 112 feeding a PAM (Power Amplifier Module) 114, which energizes the transmit array 102. The receive side includes a signal data processor control module 120 coupled to a digital receive system 122 via a universal I/O device 124, such as InfiniBand. The receive beamformer 126 receives input from the low noise amplifiers 128, which are coupled to the receive array 104.

In certain embodiments, the transmit and receive sides may be integrated in full or in part (e.g., the transmit beamformer 112 and the receive beamformer 126 may be provided from common hardware). As used herein, the term “transmit-receive system” generally refers to a system having both transmit and receive capabilities.

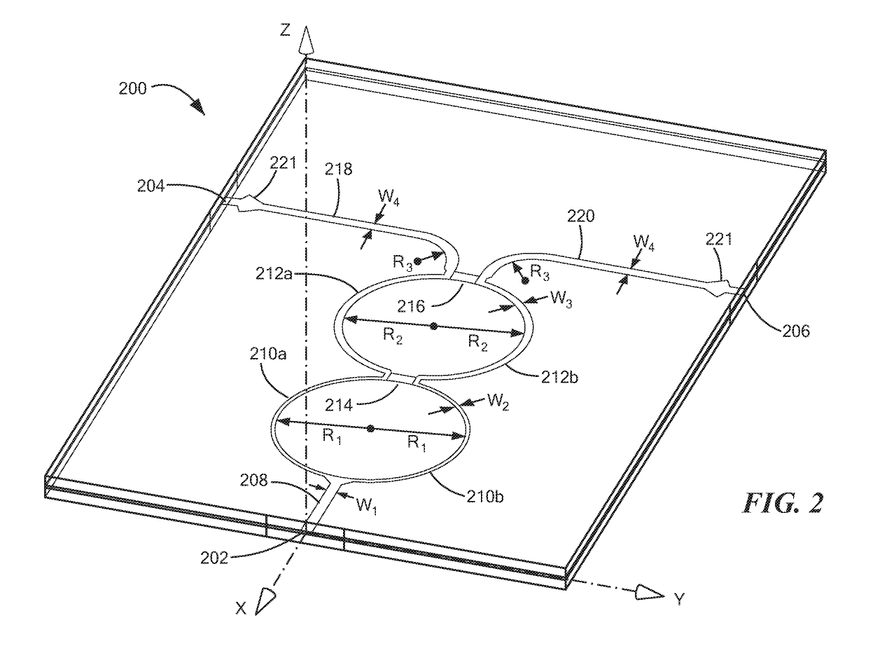

In various embodiments, transmit beamformer 112 and/or the receive beamformer 126 may be provided as via-less beamformers (i.e., beamformers that do not rely on conductive vias for mode suppression). In certain embodiments, the via-less beamformers may be fabricated using additive manufacturing (AM) techniques. In many embodiments, a beamformer 112, 126 may include one or more circuits that similar to those described below in conjunction with FIGS. 2-4.

Referring to FIG. 2, a 2:1 divider/combiner circuit 200 may form part of a via-less beamformer, according to some embodiments of the disclosure. The illustrative circuit 200 includes an input port 202 and two output ports 204, 206 (it should be appreciated that circuit 200 may be used as a power combiner, in which case ports 204, 206 may referred to as input ports and port 202 may be referred to as an output port).

The input port 202 is coupled to a first pair of quarter wave transformers 210a, 210b via a signal path 208. In turn, the quarter wave transformers 210a, 210b are coupled to respective ones of a second pair of quarter wave transformers 212a, 212b. A first resistor 214 is coupled between the first pair of quarter wave transformers 210a, 210b and a second resistor 216 is coupled between the second pair of quarter wave transformers 212a, 212b, as shown. The quarter wave transformers 212a, 212b are coupled to respective output ports 204, 206 via signal paths 218, 220. The transformers 210, 210b, 212a, 212b and/or the signal paths 208, 218, 220 may be provided as transmission lines printed onto a substrate using an AM technique. The values of resistors 214, 216 may be selected such that the two outputs 204, 206 are matched while also providing sufficient isolation therebetween. In certain embodiments, resistor 214 may have a value of about 1.5Z₀ ohms and resistor 216 may have a value of about 5.6Z₀ ohms.

It will be appreciated that the circuit 200 may be classified as a double-tuned Wilkinson divider.

In certain embodiments, the circuit 200 may include edge-launch connectors for coupling one or more of the ports 202, 204, 206 to other layers of a printed wiring board (PWB).

The layout of the circuit 200 may be selected to achieve desired electrical performance characteristics—e.g., bandwidth and/or scattering parameter (S-parameter) performance—without having to provide a series (or “fence”) of conductive vias to suppress coupling of higher-order modes between the conductors/signal paths which make up circuit 200.

It is recognized herein that bends and other circuit features can cause energy to split out into other modes of propagation besides the dominant mode (i.e., the mode where current follows the signal paths 208, 218, 220 and transformers 210, 210b, 212a, 212b). If two components of the circuit 200 are located sufficiently close together, then these other modes can cause unwanted coupling effects (or “proximity effects”) that degrade performance (e.g., introduce unwanted coupling between ports). Likewise, unwanted coupling can occur if components of the circuit 200 are located sufficiently close to components of a nearby circuit on the same circuit board.

Accordingly, in many embodiments, the layout of the circuit 200 may be selected to reduce higher-order modes such that the divider 200 acts as a single-mode device (e.g., a single TEM or quasi-TEM device). As used herein, the term “layout” refers to the geometric configuration of the circuit components (including the shape, length, and widths of signal paths), along with the type of components used (e.g., stripline, coaxial, or co-planar waveguide). In many embodiments, reactive field theory is used to determine the proximity effect of various circuit features. This information can be used to select the circuit layout to avoid (or mitigate the effects of) reactive field expansion.

In some embodiments, modal expansion (or “the modal method”) can be used to select the layout and configuration of one or more circuits within a via-less beamformer. The purpose of modal expansion is to provide a set of orthogonal basis functions, the sum of which completely characterize the total electric field distribution at any location within a PWB circuit.

In various embodiments, the following process may be used to select the circuit layout: (1) determine which circuit features can produce reactive fields; (2) separate the total field into a modal set; (3) determine the modal weighting coefficients based on geometrical and/or design features of the circuit.

When using modal expansion, the following principles may be applied.
1. Orthogonality—The basis function must be orthogonal, meaning that each is independent of the other possible basis functions, supporting a summation without interaction between the basis functions.
2. Linearity—The total field must be accurately characterized by a linear, but complex sum of the appropriately weighted basis functions. This is a condition of the linear systems that the modal expansion is intended to support. It is also consistent with solutions to the wave equation, noting that multiple solutions can be superimposed or linearly added to form a total field solution.
3. Existence conditions—The basis functions must be only those supported by the boundary conditions. To this, there are two corollary conditions. First, in order of a given mode or basis function to exist, the boundary conditions inherent in the model geometry must support it. The opposite is also appropriate; if the boundary conditions needed in order to support a given mode do not exist, then the subject mode cannot exist. Second, in order for a given mode or basis function to exist, it must be excited. The opposite is also appropriate; if a subject mode is not excited although supporting boundary conditions exist, it cannot exist.
4. Modal conversion—Each circuit element may introduce boundary conditions that produce either a geometrical conversion or an intended transfer function. These boundary conditions can also introduce an additional mode set that provides a mode set conversion. For example, a 90-degree bend may be used to change the direction of a stripline trace in order to facilitate connections or to package certain stripline features within a restricted area. A 90-degree mitered bend also introduces a boundary conditions change. In general, the conductor currents are larger on the inside corner of the bend and reduced on the outer edge, producing an inherent asymmetry in the fields between the center trace and the ground planes above and below. The asymmetric fields introduce higher-order TE fields between the ground planes, often described as parallel plate modes. The stripline boundary conditions support the TE fields, and the bend asymmetry excites them, providing the necessary conditions for mode conversion. The incident quasi-TEM field mode convert to a combination of both quasi-TEM and TE fields as a result.

The form taken by the modal expansion must meet the above conditions. Since PWB circuits in general rely on dominant TEM propagation, the associated boundary conditions often exclude or cutoff entire mode sets. A stripline geometry, for example cannot propagate the TM modes, since they are cutoff. As a result, the modal expansion may take the following form,

$${E}_{t} ( f ) = {\sum }_{n = 0}^{N} {a}_{n} {E}_{{TE}_{0 , n}} ( f )$$

The total field distribution is determined at frequency (f), and repeated for all frequencies under consideration.

The number of modes included in the modal summation is bounded by (N), and is subject to the accuracy needed and the geometrical purity. The lowest order mode under consideration is E_{TA}_{_{0,0}}(f), which is the dominant TEM supported by the geometry. The modal weighting coefficients (aₙ), which may be frequency dependent, represent the complex coefficients associated with the modes needed to characterize the total field.

It is appreciated herein that modal expansion provides a means to interpret total electric field distributions produced in a beamformer or other device. Modal expansion can be used to isolate regions of a microwave circuit where proximity effects may occur, and to expand the modes in that region in order to determine whether reactive fields are present. When such a condition exists, there are a number of design techniques that can be employed to reduce the reactive field content down to acceptable levels. Examples of such techniques include increasing the separation between circuit elements, reducing the length of transmission lines where reactive fields are present, and rounding or mitering the corners of transmission line bends.

Using the above-described technique, a stripline divider/combiner circuit suitable for operation in the 2.0 to 4.0 GHz frequency range includes a pair of substrates each having a thickness of about 20 mils and a relative permittivity (ϵᵣ) of about 3.5. Signal path 202 may have a width (W₁) of about 25 mils corresponding to a characteristic impedance of about 50 ohms and signal paths 210a, 210b may have a width (W₂) of about 7 mils corresponding to a characteristic impedance of about 80 ohms. Signal paths 212a, 212b may have width (W₃) of about 15 mils corresponding to a characteristic line impedance of about 60 ohms and signal paths 218, 220 may have a width (W₄) of about 25 mils corresponding to a characteristic line impedance of about 50 ohms. The radius (R₁) of signal paths 210a, 210b may be about 0.183 inches, the radius (R₂) of signal paths 212a, 212b may be about 0.183 inches, and the radius (R₃) of signal paths 218, 220 may be about 0.06 inches.

It should be appreciated that the above dimensions may be scaled to suit the needs of a particular application. For example, if the circuit is intended to operate in a system having a 75 ohm characteristic impedance, then the width of lines 208, 218, 220 would be adjusted accordingly. As another example, the radii R₁, R₂, R₂, may change with frequency.

In some embodiments, a via-less beamformer based on the divider circuit 200 may reduce manufacturing costs by at least 20% compared to existing systems. In many embodiments, S-parameter performance is as good as convention PWB-based circuits using conductive vias to suppress higher-order modes.

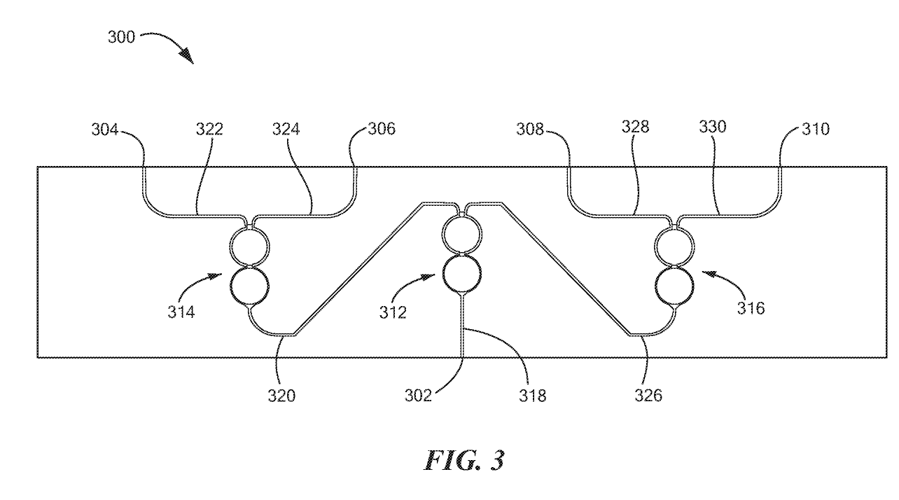

Referring to FIG. 3, a 2×2:1 (or 4:1) divider/combiner circuit 300 may form part of a via-less beamformer, according to some embodiments of the disclosure. The illustrative circuit 300 includes an input port 302 and four (4) output ports 302, 304, 306, 308. The designation of input and output ports may be reversed if the circuit 300 is being used as a power combiner. The input port 302 is coupled to an input of a first divider 312 via signal path 318. A first output of the first divider 312 is coupled to an input of a second divider 314 via signal path 320. A second output of the first divider 312 is coupled to an input of a third divider 316 via signal path 326. The outputs of the second divider 314 are coupled to output ports 304, 306 via respective signal paths 322, 324 and the outputs of the third divider 316 are coupled to output ports 308, 310 via respective signal paths 328, 330.

In some embodiments, the layout of divider circuit 300 may be selected using techniques described above in conjunction with FIG. 2 (i.e., reactive field theory and modal expansion).

In many embodiments, one or more of the dividers 312, 314, 316 may be provided as a double-tuned Wilkinson divider similar to the divider shown in FIG. 2. In certain embodiments, the signal paths 318, 320, 322, 324, 326, 328, 330 may be provided as transmission lines printed onto a substrate using an AM technique.

It will be appreciated that the illustrative circuit 300 uses a 2-level arrangement of 2:1 dividers to provide an overall 4:1 divider. This approach can be extended to provide arbitrary binomial power divisions, such as 2:1, 4:1, 8:1, 16:1, etc. It should be appreciated that the structures and techniques described herein can also be applied to non-binomial power divider circuits, for example, 3:1, 5:1, 7:1, etc. power divider circuits. In general, structures and techniques described herein can be used to realize a N:1 power divider/combiner for use in a via-less beamformer.

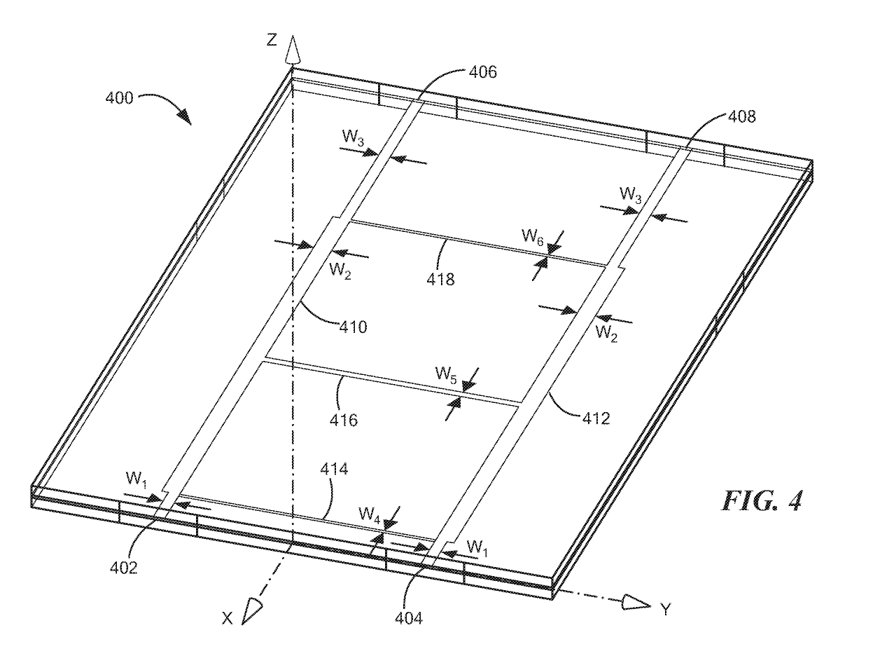

Referring to FIG. 4, branch hybrid coupler circuit 400 may form part of a via-less beamformer, according to some embodiments of the disclosure. The illustrative circuit 400 includes input ports 402, 404 and output ports 406, 408. A first signal path 410 is coupled between ports 402 and 406, and a second signal path 412 is coupled between ports 404 and 408, as shown. The signal paths 410 and 412 are arranged in a generally parallel manner to each other and are coupled by three additional signal paths 414, 416, 418. The signal paths 414, 416, 418 intersect paths 410, 412 at approximately 90-degree angles, as shown. The signal paths 410, 412 may be referred to as transmission lines, and the signal paths 414, 416, 418 may be referred to as branches.

It is appreciated herein that the 90-degree intersections of the transmission lines and the branches will generate reactive fields, causing energy to split out into other modes of propagation besides the dominant mode. Accordingly, in many embodiments, reactive field theory may be used to determine how far, and in which directions, the branch-induced reactive fields will propagate. In turn, this information can be used to select an appropriate circuit layout.

In some embodiments, the layout of a branch hybrid coupler circuit 400 may be selected using techniques described above in conjunction with FIG. 2 (i.e., reactive field theory and modal expansion).

For example, using the aforementioned techniques, a branch hybrid coupler circuit suitable for operation in the 2.0 to 4.0 GHz frequency range includes a pair of substrates each having a thickness of about 20 mils and a relative permittivity (ϵᵣ) of about 3.5. The transmission lines 410, 412 may include multiple segments with different impedances. For example, each transmission line may include a first section having a width (W₁) of about 24 mils corresponding to a characteristic impedance of about 44 ohms, a second section having a width (W₂) of about 30 mils corresponding to a characteristic impedance of about 38 ohms, and a first section having a width (W₃) of about 24 mils corresponding to a characteristic impedance of about 44 ohms. A first branch 414 may have a width of about 3 mils corresponding to a characteristic impedance of about 100 ohms, a second branch 416 may have a width of about 12 mils corresponding to a characteristic impedance of about 64 ohms, and a third branch 418 may have a width of about 3 mils corresponding to a characteristic impedance of about 100 ohms.

It should be appreciated that the above dimensions may be scaled to suit the needs of a particular application.

All references cited herein are hereby incorporated herein by reference in their entirety.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A via-less beamformer comprising:
a plurality of circuits, each of said plurality of circuits having circuit layouts selected to mitigate unwanted reactive coupling there between, at least one of said plurality of circuits comprising:
a divider/combiner circuit including:
a first signal path having a first end corresponding to a first port of the beamformer and having a second end;
a first pair of signal paths, each of said first pair of signal paths having a radius and having first ends coupled to the second end of said first signal path;
a second pair of signal paths, each of said second pair of signal paths having a radius and having first and second ends, with second ends of said first pair of signal paths coupled to first ends of respective ones of said second pair of signal paths; and
a third pair of signal paths having first and second ends, with second ends of respective ones of said second pair of signal paths coupled to first ends of respective ones of said third pair of signal paths and wherein second ends of said third pair of signal paths correspond to second and third ports of said divider/combiner circuit.

2. The via-less beamformer of claim 1 wherein each of said third pair of signal paths is provided having a radius at a portion thereof proximate the first ends of said third pair of signal paths.

3. The via-less beamformer of claim 2 wherein at least one of said plurality of circuits is provided having a circuit layout selected based upon reactive field theory.

4. The method of claim 3 wherein at least one of said plurality of circuits has a circuit layout selected by: determining which circuit features produce reactive fields in response to signals provided thereto, separating the total field into a modal set, and determining the modal weighting coefficients based on geometrical and/or design features of one or more of said plurality of circuits.

5. The via-less beamformer of claim 1 wherein the one or more circuits are manufactured using additive manufacturing (AM) techniques.

6. The via-less beamformer of claim 1 wherein the divider/combiner circuit is an N:1 divider/combiner circuit, where N is an integer multiple of two.

7. The via-less beamformer of claim 1 wherein the divider/combiner circuit comprises a plurality of 2:1 Wilkinson divider/combiner circuits coupled in a cascading arrangement.

8. The via-less beamformer of claim 1 wherein at least one of said plurality of circuits comprises a branch hybrid coupler including a plurality of transmission lines and a plurality of branches, each of the transmissions lines having at least two segments having different widths.

9. A via-less beamformer comprising:
a plurality of via-less circuit elements, each of said plurality of via-less circuit elements having a circuit layout selected to mitigate unwanted reactive coupling therebetween, at least one of said plurality of via-less circuit elements corresponding to a via-less branch hybrid coupler circuit, each of said at least one via-less branch hybrid coupler circuit comprising:
a plurality of transmission lines each having at least two segments having different widths; and
a plurality of branches each having a width which is different from a width of said plurality of branch hybrid coupler transmission lines and wherein a first end of one of said plurality of transmission lines corresponds to a first port of the via-less beamformer and a second end of one of said plurality of transmission lines is coupled to one of said plurality of via-less circuit elements.

10. The via-less beamformer of claim 9 wherein a second end of one of said plurality of branch hybrid coupler circuit transmission lines is coupled to a second a via-less branch hybrid coupler circuit.

11. The via-less beamformer of claim 10 wherein each of said at least one via-less branch hybrid coupler circuit has a circuit layout selected based upon reactive field theory.

12. The method of claim 11 wherein at least one of said via-less branch hybrid coupler circuits has a circuit layout selected by:
determining which circuit features of said via-less branch hybrid coupler circuits produce reactive fields in response to a signal provided thereto;
separating the total field into a modal set; and
determining the modal weighting coefficients based on geometrical and/or design features of said via-less branch hybrid coupler circuit.

13. The via-less beamformer of claim 12 wherein said one or more via-less branch hybrid coupler circuits are manufactured using additive manufacturing (AM) techniques.

14. The via-less beamformer of claim 10 comprising:
at least one via-less Wilkinson divider/combiner circuit having at least one port coupled to a port of said at least one via-less hybrid coupler circuit.

15. The via-less beamformer of claim 14 wherein each of the at least one branch hybrid coupler circuits comprises:
a plurality of transmission lines; and
a plurality of branches, each of said plurality of transmission lines having at least two segments having different widths.

16. The via-less beamformer of claim 14 wherein said at least one via-less Wilkinson divider/combiner circuit comprises:
a first signal path having a first end corresponding to a first port of the beamformer and having a second end;
a first pair of signal paths, each of said first pair of signal paths having a radius and having first ends coupled to the second end of said first signal path;
a second pair of signal paths, each of said second pair of signal paths having a radius and having first and second ends, with second ends of said first pair of signal paths coupled to first ends of respective ones of said second pair of signal paths; and
a third pair of signal paths having first and second ends, with second ends of respective ones of said second pair of signal paths coupled to first ends of respective ones of said third pair of signal paths and wherein second ends of said third pair of signal paths correspond to second and third ports of said divider/combiner circuit.

17. A phased array radar system comprising:
one or more phased array antennas;
a transmit-receive system coupled to the one or more phased array antennas;
at least one of said phased array antenna, said transmit-receive system comprising a via-less beamformer, said via-less beamformer comprising:
a plurality of circuits having layouts selected to mitigate unwanted reactive coupling there between, at least one of said plurality of circuits comprising:
a divider/combiner circuit including:
a first signal path having a first end corresponding to a first port of the beamformer and having a second end;
a first pair of signal paths, each of said first pair of signal paths having a radius and having first ends coupled to the second end of said first signal path;
a second pair of signal paths, each of said second pair of signal paths having a radius and having first and second ends, with second ends of said first pair of signal paths coupled to first ends of respective ones of said second pair of signal paths; and
a third pair of signal paths having first and second ends, with second ends of respective ones of said second pair of signal paths coupled to first ends of respective ones of said third pair of signal paths and wherein second ends of said third pair of signal paths correspond to second and third ports of said divider/combiner circuit.

18. The phased array radar system of claim 17 wherein said one or more phased array antennas is provided as a single phased array antenna and wherein said transmit-receive system is coupled to said single phased array antenna.

19. The phased array radar system of claim 17 wherein:
said one or more phased array antennas comprises a transmit phased array antenna and a receive phased array antenna;
said transmit-receive system includes a transmit side coupled to said transmit phased array antenna and a receive side coupled to said receive phased array antenna.

20. The phased array radar system of claim 17 wherein at least one of said plurality of circuits in said via-less beamformer is provided as a via-less branch hybrid coupler, said via-less branch hybrid coupler comprising a plurality of transmission lines and a plurality of branches, each of said plurality of transmissions lines having at least two segments having different widths and wherein said via-less branch hybrid coupler circuit has a circuit layout selected by:
determining which circuit features of said via-less branch hybrid coupler circuit produces reactive fields in response to a signal provided thereto;
separating the total field into a modal set; and
determining the modal weighting coefficients based on geometrical and/or design features of said via-less branch hybrid coupler circuit.
